(19) United States
(12) Patent Application Publication
(10) Pub. No.: US 2005/0060458 A1
(43) Pub. Date: Mar. 17, 2005

(54) Method and apparatus for sharing a device among multiple CPU systems

(76) Inventor: In-chul Yu, Suwon-si (KR)

Correspondence Address: John E. Holmes;ROYLANCE, ABRAMS, BERDO & GOODMAN, L.L.P., Suite 600, 1300 19th Street, Washington, DC, 20036, US

(21) Appl. No.: 10/885,657

(22) Filed: Jul. 8, 2004

(30) Foreign Application Priority Data
Sep. 2, 2003 (KR) 10-2003-0061083

(51) Int. Cl. G06F 12/00; G06F 13/14; G06F 13/38

(52) U.S. Cl. 710/240

(57) ABSTRACT

The present invention provides a method and apparatus enabling multiple CPU systems to independently access a shared device, each of the multiple CPU systems having data I/O lines, a reset line, a clock line and the like without requiring an additional switching logic or circuit. The method of sharing the device among multiple CPU systems according to an embodiment of the present invention comprises setting interfaces of all the systems to a floating state, determining the status of a PIO indicating whether it is possible to access the device, and the status of the PIO to an access-disable state. The method of sharing the device among multiple CPU systems further comprises changing the status of an interface of a first system, which intends to access the device, so that communications can be made between the first system and the device, and transmitting and receiving data between the first system and the device.

### PRIORITY

This application claims priority under 35 U.S.C. §119(a) of Korean Patent Application No. 10-2003-0061083 filed on Sep. 2, 2003, in the Korean Intellectual Property Office, the entire contents of which are incorporated herein by reference.

### BACKGROUND OF THE INVENTION

1. Field of Invention

The present invention relates to a method of sharing one device among multiple systems. More particularly, the present invention relates to a method and apparatus enabling two systems in two or more systems each having central processing units (CPUs) to independently access a specific device having data I/O lines, a reset line, a clock line and the like without requiring additional switching logic or circuit(s). The present invention can be applied to systems that share a security device required for a conditional access system (CAS) in a set-top box with two or more tuners, and the like.

2. Description of the Related Art

FIG. 1 shows input/output (I/O) terminals of a device that multiple systems intend to share with one another.

Generally, I/O lines of the device include a CLOCK line 1, a RESET line 2, a DATA VALID IN line 3, a DATA VALID OUT line 5, a DATA IN line 4 and a DATA OUT line 6. Alternatively, the device can comprise additional I/O lines.

The CLOCK line 1 functions to receive a clock signal from a system and the RESET line 2 functions to receive a hardware reset (initialization) command. Further, the DATA VALID IN line 3 and the DATA VALID OUT line 5 function to input and output a DATA VALID signal indicating a valid section of received data, respectively. Moreover, the DATA IN line 4 and DATA OUT line 6 function to input and output data signals that are to be actually transmitted, respectively.

FIG. 2 illustrates a timing diagram of illustrating the relationship between a clock signal 10, a DATA VALID signal 20 and a data signal 30. As shown in FIG. 2, the data begins to be transmitted just after the clock signal 10 starts. Even though data signal 30 can be transmitted during a period of time in which the clock signal 10 does not exist, such data signal is ignored. In the example shown in FIG. 2, the data signal is read at a point when the clock signal 10 rises from a low level to a high level; however, it is also possible that the data signal can be read at a point when the clock signal 10 falls from the high level to the low level. In addition, since the data signal 30 is recognized as valid data only when the DATA VALID signal 20 is high, the data signal is ignored when the DATA VALID signal 20 is low. In FIG. 2, within the DATA VALID section, the results of reading the data signal 30 at points when the clock signal 10 rises from the low level to the high level are high (rising clock pulse), are low (or a logic level “0” bit), low and high (a logic level “1” bit), which can be interpreted as 1, 0, 0 and 1.

FIG. 3 is a block diagram illustrating a configuration in which multiple systems utilize a shared device in the related art.

The configuration illustrated in FIG. 3 can comprise the multiple systems 100 and 200, the shared device 300 that the systems 100 and 200 intend to share with each other and access, a logic module 400, I/O lines, inter processor communication (IPC) lines and selection pins 110 and 210.

The I/O lines comprise six terminals (1 to 6 in FIG. 1) shown in FIG. 1 and serve as paths through which the systems access the shared device. In addition, the logic module 400 functions to switch the I/O lines. Further, the selection pins, i.e. S1 110 and S2 210, allow one of the multiple systems 100 and 200 to select an access path so that the system can access the shared device 300. The IPC line functions to confirm whether another system is using the shared device 300 when a given system intends to access the shared device 300.

Operation of the configuration in the related art shown in FIG. 3 is as follows: First, suppose first system 100 of the two systems 100 and 200, which intend to access the shared device, enables the selection pin 110 and determines a signal path. When one signal path is determined in such a manner, all other paths are blocked. Thereafter, a clock signal is generated to drive the shared device 300 and the hardware is reset. A command is transmitted through the DATA IN line (pin 4 in FIG. 1) and the DATA VALID IN line (pin 3 in FIG. 3) according to a predetermined communication protocol. Then, the shared device 300 executes the command, and transmits the execution results to the system which transmitted the command, through the DATA OUT line (pin 6 in FIG. 1) and the DATA VALID OUT line (pin 5 in FIG. 1) according to the predetermined protocol. Thereafter, when the second system 200 intends to access the shared device 300, it confirms through the IPC whether the first system 100 currently accesses the shared device 300. When the first system finishes using the shared device 300, the second system 200 can repeat the process of accessing the shared device 300, as described above.

A typical example of the shared device is a security device required for a conditional access device in a set-top box having two or more tuners. A single security device provided in the one set-top box that includes multiple systems is convenient, and the aforementioned method can be applied to this type of configuration. There are problems, however, of increasing costs due to an additional circuit(s) or logic, reliability problems resulting from path switching for signals that includes the clock signal, and problems of synchronization when the systems mutually access the device.

Another conventional method exists, wherein multiple systems independently utilize multiple devices, respectively, considering that two systems cannot directly share input and output of a desired device to be shared and a clock signal for driving the device. However, since protocols or data formats for most of security devices are not available, it is common to access them independently by using system chips for supporting access to the devices. In this case, security is good, but a number of security devices must be installed in one set-top box with multiple CPU systems in order to provide the function of conditional access or authorization. Therefore, it is inconvenient and economically inefficient.

In addition, there is another conventional method, wherein a security device is attached to a first system 100 and a second system 200 transmits and receives data to and from the security device through an interface with the first system. However, there is a serious problem in that security cannot be ensured during communications between the first and second systems.

### SUMMARY OF THE INVENTION

An object of the present invention is to substantially solve at least the above problems and/or disadvantages and to provide at least the advantages described below. Accordingly, it is an object of the present invention to provide a method of providing a specific level of security in a multiple CPU system without additional logic circuitry.

Another object of the present invention is to provide a method of enabling multiple systems to independently access a shared device without changing I/O ports and a protocol of the shared device.

According to one aspect of the present invention for achieving the objects discussed above, a method is provided for sharing a device among multiple CPU systems, comprising setting interfaces of all the systems to a floating state, determining the status of a programmed input/output (PIO) indicating whether it is possible to access the device, and setting the status of the PIO to an access-disable state. The method for sharing a device among multiple CPU systems further comprises changing the status of an interface of a first system, which intends to access the device, so that communications can be made between the first system and the device and transmitting and receiving data between the first system and the device.

According to another aspect of the present invention, there is provided an apparatus for sharing a device among multiple systems wherein the apparatus comprises the multiple systems, each includes a CPU, a shared device that the multiple systems intend to access, and a PIO that is connected among the multiple systems and indicates whether it is possible to access the shared device. The apparatus for sharing a device among multiple systems further comprises input/output lines that are connected among the multiple systems and the shared device and serve as a data transmission path. In accordance with the embodiments of the present invention, the input/output lines are set to a floating state when the multiple systems do not access the shared device, and the status of an interface is changed and set such that when one of the multiple systems accesses the shared device, the system can access the shared device.

### BRIEF DESCRIPTION OF THE DRAWINGS

The above and other objects, features and advantages of the present invention will become apparent from the following description of preferred embodiments given in conjunction with the accompanying drawings, in which:

FIG. 1 illustrates input/output (I/O) terminals of a conventional device that multiple systems intend to share with one another;

FIG. 2 illustrates a conventional timing diagram in which data are received through a clock signal, a DATA VALID signal and a data signal;

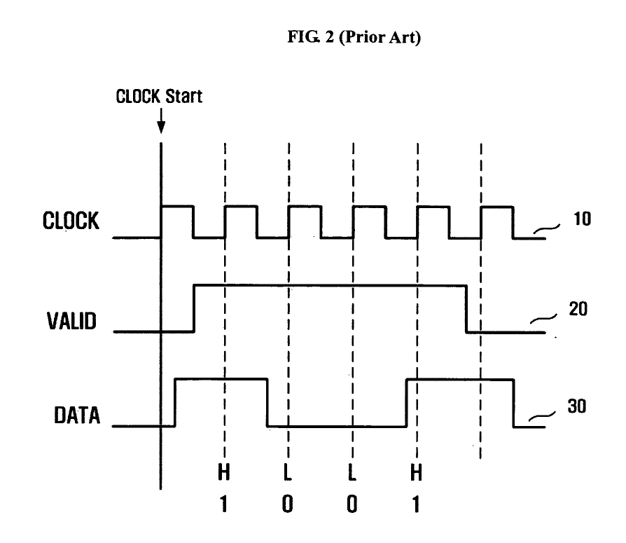

FIG. 3 is a block diagram illustrating a configuration in which multiple systems utilize a shared device in a conventional system;

FIG. 4 is a block diagram illustrating the configuration of an apparatus according to an embodiment of the present invention; and

FIG. 5 is a flowchart illustrating operation of an apparatus configured according to an embodiment of the present invention.

### DETAILED DESCRIPTION OF THE PREFERRED EMBODIMENTS

Several embodiments of the present invention will now be described in detail with reference to the annexed drawings. In the drawings, the same or similar elements are denoted by the same reference numerals even though they are depicted in different drawings. In the following description, a detailed description of known functions and configurations incorporated herein have been omitted for conciseness.

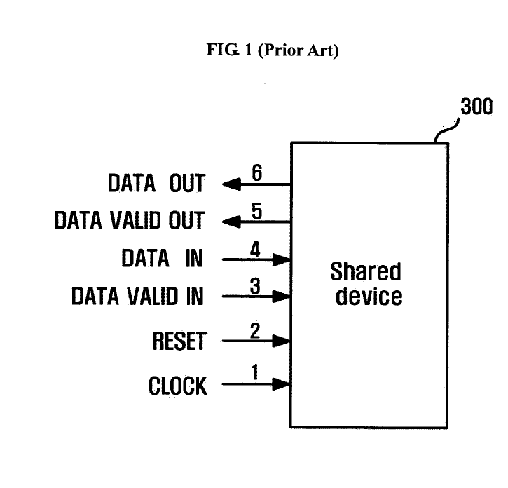

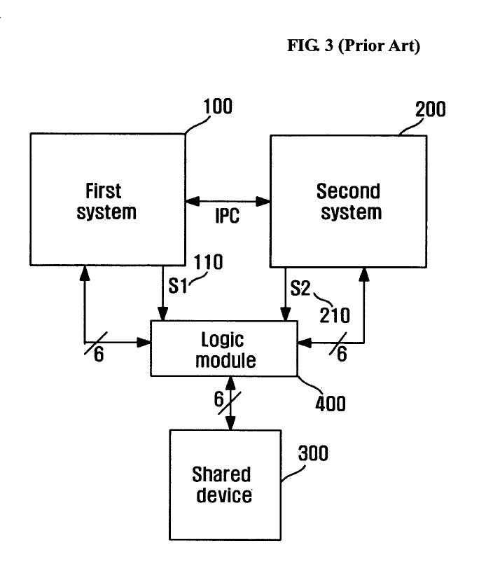

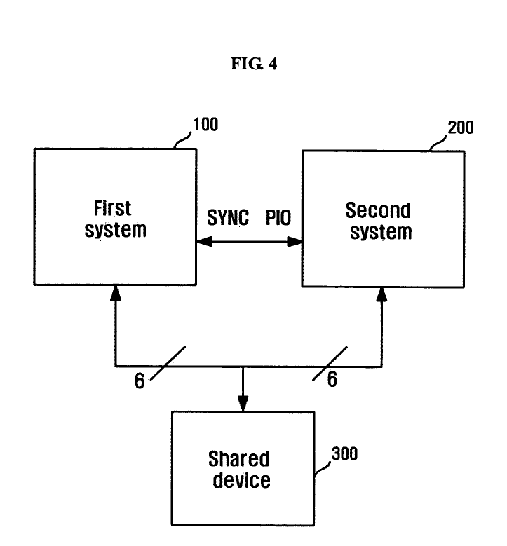

A hardware configuration according to an embodiment of the present invention is shown in FIG. 4. Six I/O lines (1 to 6 in FIG. 1) conventionally required for access to a device are connected among two systems and a device to be shared in a direct pin-to-pin manner, and a single, commonly used programmed input/output, (PIO) is allocated between systems for the purpose of synchronization of mutual access. In an embodiment of the present invention, the PIO connected between the systems to be synchronized with each other, i.e. to make a determination on whether it is possible to access the shared device, is defined as a “SYNC PIO”. In an embodiment of the present invention, the systems are connected to each other with the SYNC PIO rather than the IPC as shown in FIG. 3. Therefore, it is necessary only to discriminate between a low logic level and a high logic level in the hardware without the use of an additionally defined protocol for allowing reception and transmission of information between the two systems as used by the IPC.

Since the clock line (1 in FIG. 1) corresponds to an input terminal in the shared device, a conflict inevitably occurs between the two systems if clocks of the systems are simultaneously output to the device. Therefore, according to an embodiment of the present invention, the clock line is shared as a floating line. The clock line is constructed as an alternative PIO only in a system requesting access thereto, so that the system can generate a clock and communicate with the shared device. Thereafter, the clock line is again in a floating PIO state, so that access can be gained only when required without affecting a counterpart system. Here, the term “floating state” means a state in which it is impossible to determine whether the line is in a high or low state, that is, to recognize whether it has a logic value of 1 or 0.

In an embodiment of the present invention, the input/output lines connecting the systems 100 and 200 to the shared device 300 are connected to respective interfaces of the systems 100 and 200 and the shared device 300. The interfaces can support GPIO. Most system chips currently used support GPIO. GPIO is multiplexed to use all of the normal PIO, alternative PIO, floating PIO and the like, thereby allowing a user to select the desired mode if necessary. A normal PIO mode indicates the situation in which the user separately defines and operates the input/output terminals (1 to 6) shown in FIG. 1. The alternative PIO mode indicates the situation in which the respective input/output terminals can be automatically operated without defining the respective terminals by the user only if connection is made. The floating PIO mode indicates the situation in which neither a high state nor a low state is achieved.

An embodiment of the present invention enables the I/O and clock lines shared among the multiple systems to independently allow multiple accesses without conflict among the pins by properly using pin configurations provided by the system chips. Since a communication protocol used in the embodiment of the present invention can be selected among conventional protocols, a detailed description thereof will be omitted.

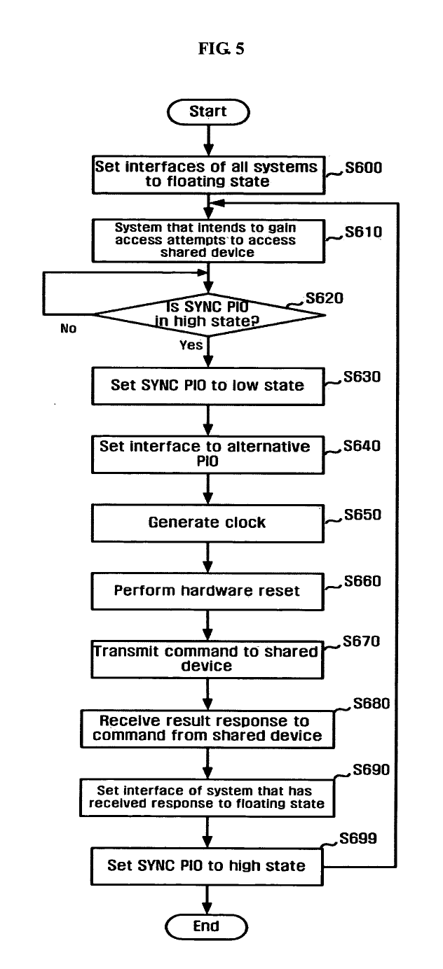

FIG. 5 is a flowchart illustrating operation of an apparatus configured according to an embodiment of the present invention. The method for operation of an apparatus configured according to an embodiment of the present invention begins in an initial or normal state, wherein both the systems set all of the interface lines with the shared device to the floating state, and thus maintaining an idle state (S600). In order to match the access sync of the two systems with each other, the PIO is always maintained in the high level before access, and falls to the low level only during access.

Next, one system (a first system) that intends to access the shared device attempts to gain access to the shared device (S610). During this time, the method determines whether the SYNC PIO is in a high state in decision step S620. If the SYNC PIO is in a low state (“No” path from decision step S620), this means that another system is already accessing the shared device, and the first system must wait until the sync PIO is released to the high state (“Yes” path from decision step S620).

If the SYNC PIO is a high state (“Yes” path from decision step S620), the system that intends to access the shared device the first system, asserts the SYNC PIO to the low state (S630), and sets all PIOs as alternative PIOs for interfacing with the shared device (S640). Therefore all the input/output lines (1 to 6 in FIG. 1), such as the clock line and the reset line, are set as alternative PIOs to ensure a protocol in which security is guaranteed. Although this embodiment of the present invention uses the alternative PIO, it can use the normal PIO, if necessary. Although the system that intends to access the shared device is set to the alternative PIO, other systems maintain the floating input state. Thus, an I/O conflict does not occur.

Next, in step S650, the system that intends to access the shared device 300, the first system, generates a clock for driving the shared device 300 and applies it to the shared device 300. Then, a hardware reset is performed using the reset line (2 in FIG. 1) to wake up the shared device 300 (S660).

A command is then transmitted to the shared device through the DATA IN line (4 in FIG. 1) and the DATA VALID IN line (3 in FIG. 1) using a predetermined protocol (S670). The shared device 300 receives and executes the command. The shared device 300 then transmits the results of the execution to the system, which has transmitted the command, through the DATA OUT line (6 in FIG. 1) and the DATA VALID OUT line (5 in FIG. 1) (S680).

The interface lines that have been set as the alternative PIOs between the first system and the shared device are again set to the floating state (S690). Thereafter, the SYNC PIO is switched to the high state to wait for the next access (S699).

According to an embodiment of the present invention, the apparatus in which multiple systems can access a shared device has an advantage in that since multiple systems can share the device with one another by simply configuring a circuit in a pin-to-pin manner without an additional logic circuit, material costs can be reduced.

Further, according to an embodiment of the present invention, there is an advantage in that independent access can be gained by changing only PIO configurations of system chips without changing PIOs and a protocol of a security device to support a dual system.

Moreover, according to an embodiment of the present invention, it is possible to implement synchronization by simply using only the SYNC PIO without requesting a counterpart to permit the use of a shared device. Accordingly, there are advantages in that material costs of final products can be reduced and purchaser's requirements can also be satisfied, thereby improving the quality of the product and enabling the secured technique to be applied to similar products.

Furthermore, according to an embodiment of the present invention, there is an advantage in a digital broadcast receiver with multiple tuners, in that a conditional access device with a single security device can be implemented.

Although the present invention has been described in connection with the embodiments of the present invention illustrated in the accompanying drawings, it will be readily understood by those skilled in the art that the present invention can be embodied into other specific forms without changing the technical spirit or essential features of the present invention. Therefore, it should be understood that the embodiments are not meant to limit the scope of the present invention, but are merely illustrative of certain aspects. The scope of the present invention is defined by the appended claims rather than the detailed description, and all changes and modifications derived from the meaning and scope of the claims and their equivalents should be construed as falling within the scope of the invention.

1. A method of sharing a device among at least two CPU systems, comprising:
setting interfaces of all the at least two systems to a floating state;
determining the status of a programmable input/output line (PIO) indicating whether it is possible to access the shared device;
setting the status of the PIO to an access-disable state;
changing the status of an interface of a first system, which intends to access the device, so that communications can be made between the first system and the shared device; and
transmitting and receiving data between the first system and the shared device.

2. The method as claimed in claim 1, further comprising:
setting the interface of the first system to the floating state after the transmitting and receiving step ; and
setting the status of the PIO to an access-allowable state.

3. The method as claimed in claim 1, wherein the PIO is a SYNC PIO.

4. The method as claimed in claim 1, wherein the access-disable state is a logic level low state and the access-allowable state is a logic level high state.

5. The method as claimed in claim 1, further comprising:
determining whether the status of the PIO is an access-allowable state following the determining step and preceding the step of setting the status of the PIO line;
waiting until the status of the PIO becomes the access-allowable state if it is determined that the status of the PIO is an access-disable state.

6. The method as claimed in claim 1, wherein the changed status of the interface of the first system is an alternative PIO.

7. The method as claimed in claim 1, wherein step of transmitting and receiving comprises:
generating a clock for driving the shared device and applying it to the shared device;
performing a hardware reset using a reset line to wake up the shared device; and
transmitting a command to the shared device and receiving results from the transmittal command.

8. The method as claimed in claim 1, wherein the shared device is a security device required for a conditional access system of a digital broadcast receiver.

9. An apparatus for sharing a device among at least two CPU systems, comprising:
a shared device adapted to be accessed by the at least two CPU systems;
a PIO adapted to be connected among the multiple systems and indicate whether it is possible to access the shared device; and
input/output lines adapted to be connected among the multiple systems and the shared device and further adapted to serve as a data transmission path wherein the input/output lines are set to a floating state when the multiple systems do not access the shared device, and the status of an interface is changed and set such that when one of the at least two CPU systems accesses the shared device, one of the CPU systems can access the shared device.

10. The device as claimed in claim 9, wherein the status of the PIO is adapted to be set to an access-allowable state while the at least two CPU systems do not access the shared device, and it is adapted to be set to an access-disable state while one of the at least two CPU systems is accessing the shared device.

11. The device as claimed in claim 9, wherein the changed status of the interface is an alternative PIO.

12. The device as claimed in claim 10, wherein the access-disable state is a logic level low state and the access-allowable state is a logic level high state.

13. The device as claimed in claim 9, wherein each of the at least two CPU systems comprises:
a means adapted to generate a clock for driving the shared device and further adapted to apply the generated clock to the shared device;
a means adapted to perform hardware reset using a reset line to wake up the shared device; and
a means adapted to transmit a command to the shared device and receiving results for the command.

14. The device as claimed in claim 9, wherein the shared device is a security device required for a conditional access system of a digital broadcast receiver.
